(19) United States
(12) Patent Application Publication
(10) Pub. No.: US 2008/0204563 A1
(43) Pub. Date: Aug. 28, 2008

(54) Picture Freeze Detector

(76) Inventor: Frode Grindheim, Etne (NO)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/628,298

(22) PCT Filed: Jun. 2, 2005
(86) PCT No.: PCT/NO05/00182

§ 371 Date: Dec. 13, 2007

Related U.S. Application Data
(60) Provisional application No. 60/603,545, filed on Aug. 24, 2004.

(30) Foreign Application Priority Data
Jun. 4, 2004 (NO) 2004 2316

(51) Int. Cl. H04N 7/18

(52) U.S. Cl. 348/208.14; 348/E17.002

(57) ABSTRACT

The present invention describes a method and system for identifying a picture freeze situation on a display by adding a repeated electronic signature in the signal chain fed to the display, and detecting if the electronic signature is present on the display. If the electronic signature is not present a warning unit will be activated.

### FIELD OF THE INVENTION

The present invention relates to displays containing a plurality of pixels. More specifically, the invention relates to a system and method for detecting if this type of display fails to update picture data sent to it.

### BACKGROUND OF THE INVENTION

Today most ships use electronic maps, radars and other types of electronic instruments with some sort of display or monitor for presenting information. On critical systems there are requirements for an independent backup system in case of a unit failing. For a display this usually means that the crew can watch the same information on a different display.

This system works fine as long as the crew is aware of the fact that a display has failed and is not being updated with new information.

It is possible to know when a CRT (Cathode Ray Tube) based display fails, because the CRT will either go black or end up with a single sharp white dot. These events can easily be detected by viewing the display.

New displays like TFT (Thin Film Transistor) have been used in electronic equipment for several years, and are now replacing CRT displays. TFT displays are a type of LCD (Liquid Crystal Display) displays.

The signal chain of a TFT display or monitor utilizes different types of hardware components that may all contain some form of memory. Typically the video source, video mux, display controller and panel all can or will contain memory. The problem is that if there is a hardware or software error in any of these units, the picture data will stay in the memory. This can cause the picture on the display to freeze, i.e. the picture looks fine, but is not being updated.

A crew on a ship may use from seconds to minutes to realize that the information on the display has not been updated. This means that the crew has been using obsolete information for some time, and this can in turn cause a serious problem. If for instance a TFT monitor displays a map with a dynamic and updated position of the ship, based on radar or GPS, the ship may have moved a long distance and might be on collision course or closer to land than planned before the situation can be controlled. The risk is obvious.

The applicant is not aware of any methods or systems capable of warning when a display freezes. There exists however different kinds of watch dog timers explained below.

Software has a tendency to crash from time to time. This happens usually due to programming errors, noise on signals or other factors. A standard way of protecting the integrity of a system is to use watch dog timers by using additional hardware and let the software trigger this hardware at regular intervals. If the hardware is not triggered in due time, some kind of action will restore the integrity of the system. This is usually done either by activating an IRQ or restarting the system.

The intension of this technique is to fix the problem at hand and not to warn the user. For ordinary computers there is usually no other alternative than to perform a restart. In such cases it will normally take some time before the user detects the event. This method will only work on a single unit in the signal chain, and is currently used in the video source and in some display controllers.

The present invention will overcome the limitations of existing solutions by providing a method and system which can protect the entire signal chain. If an electronic signature, i.e. controlled variable electronic signal, is implemented in the video source, then all elements from the generation of the picture to the display will be protected. No other similar method or system is known.

The invention thus describes a novel method and system being able to detect a frozen picture regardless of where in the signal chain the error occurs.

In many applications a combination of watch dog timers and a system according to the present invention are preferred. Watch dog timers will try to keep max up time of the system, while the picture freeze detector can warn or reset the screen, or the different devices in the signal chain to the screen, in case of an frozen picture.

### SUMMARY OF THE INVENTION

The present invention describes a method and system for identifying a picture freeze situation on a display by adding a repeated electronic signature in the signal chain fed to the display, and detecting if the electronic signature is present on the display. If the electronic signature is not present a warning unit will be activated.

Other features are set forth in the appended claims.

### DETAILED DESCRIPTION OF THE INVENTION

The invention will now be described in detail with reference to the drawings where:

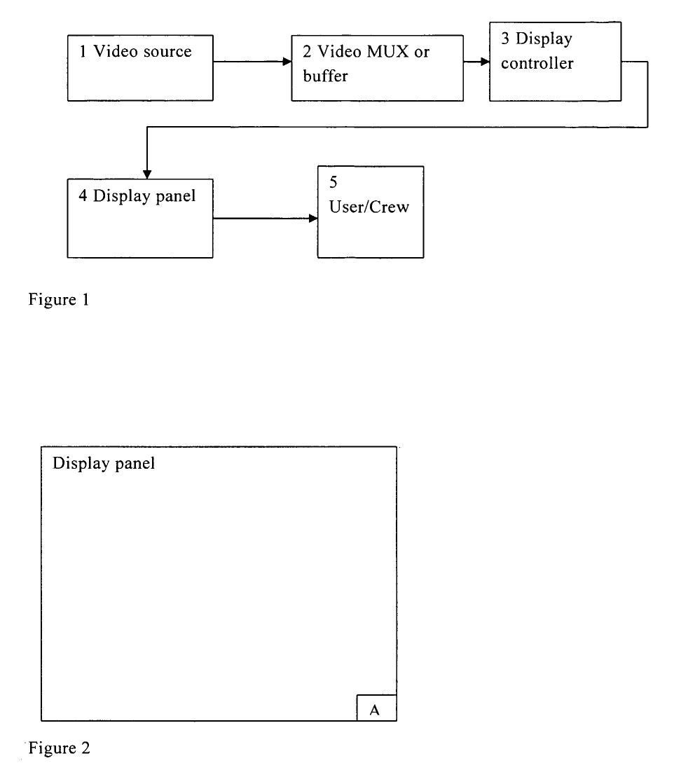

FIG. 1 shows a typical video setup, and

FIG. 2 shows a defined group of pixels that can be used for signature sending and detection.

FIG. 1 shows a typical video setup for a TFT display that may be used on a ship bridge.

In modern systems, the video source 1 is usually a more or less a standard computer running a dedicated application, like a map or radar. The format of the video source is not relevant to the present invention, but current industrial standards are Composite video, Component Video, S-Video, VGA and DVI. The remaining blocks shown in the figure may or may not use different video formats.

In larger systems it is often necessary to view the same picture on several displays. At the same time it may be necessary to select which picture to display on each display. The video mux and buffers block 2 is added to show this.

On current generation of displays, the display controller 3 is the first block that the video signal enters. The display controller 3 is responsible for video scaling and adoption of the video signal to the characteristics of the TFT display. In future display generations this unit may be partly or completely removed. This is due to the fact that it is possible to eliminate the need for signal adoption on DVIs, and instead use a video signal already adopted for the source.

The display panel 4 is the device that displays a picture to a user 5. It usually comprises a backlight source and a system enabling the display of many points of different colours. Usually a TFT will consist of a light source, a set of colour filters and a device which let or do not let light through. A LED based display will usually have one light source for each colour in each pixel.

The detailed setup shown in FIG. 1 is not directly relevant for the invention, but gives an understanding of the problems with today's technology and improvements that can be made.

The solution to the problem is to add logic to detect if picture freeze have happened and then take an appropriate action. The following description describes the inventive method for detecting a picture freeze situation.

How to handle a picture freeze is highly application specific. Examples of handling is sending a SMS, voice message, mail, alarm tone, alarm lights, computer log, turn off part of or the entire display, e.g. the display goes black or white in case of problems, or any other appropriate means of handling the situation. A full or partly restart of the system is also feasible.

If the picture freezes then there will be no updates in the picture. If a variable signature is added to the video signal it will be lost if the picture freezes. This event can then be detected.

There are several ways of adding and detecting the signature, but the basic principle of doing so is the same for all solutions.

The best place to add a signature is in the first location of the signal chain, which is the video source. This will provide protection of the entire signal chain from computer to the pixels in the display. The signature can however be added at any location in the signal chain, but will then only protect part of it.

Detection of the signature in the picture signal stream can be performed in two ways.

One method is searching for the signature by detecting how it causes one or more pixels to be updated. This detection can be done by detecting electrical field, magnetic field or by some form of direct connection to the pixel.

In a preferred embodiment of the invention the signature is spread to pixels with different locations in the picture. It is then hard for the eye to detect that the colour or light in these pixels are modulated. A signature can therefore be added without limiting the size or disturbing the picture to be displayed.

One can also apply an electronic signature hiding in the picture by using steganographic technology.

If the signature appears according to a predetermined pattern, it can be concluded that display is updated and everything works fine. If this is not the case, an alarm can be activated.

The advantage of this method is that it does not have to use extra devices like optical detectors. The detection method is however relatively complex and is best left to the display panel manufacturer, since the best place to place the electronics and logic is on the display panel itself, or inside the display panel.

Another method which is easier to implement in low volumes is to use a block of pixels located in the proximity to each other.

FIG. 2 shows how one defined group of pixels can be used for detecting a frozen picture on a display by detecting a signature with changing physical parameters. These parameters can for instance be intensity, position or colour. One can then place an optical detector on the relevant location of the display panel and decode the output signal from the detector. If the detector detects that the signature is missing, an alarm can be activated.

Some drawbacks can be foreseen by using the second method described above. Many applications require displays to be operated in almost complete darkness, e.g. ship bridges and airplanes. This is usually solved by allowing the light in the display to be reduced to complete darkness. But the detector will require at least some light to work. This can in turn be solved by detecting that there are too little light and disable the detection logic if the situation occurs. Deactivation of the detection logic should be indicated somehow.

Based on the above, it is understood that the first method is the preferred method. The following describes four examples of implementing the invention.

### EXAMPLE 1

### Changing Pattern

If the backlight of the display is stable (always on or similar), it is fairly easy to implement the inventive method. The best way of doing this is to add the signature in the video generator and then use a photo detecting device in front of the display to detect this signature. In its simplest form the signature can be a small block of pixels which changes from black to white at a regular interval. As long as this changing pattern is detected by the sensor everything is fine and the video system is working as expected. If the pattern is missing then there is a problem and an alarm can be activated.

If operation in pore light conditions is necessary it might not be enough light to perform the detection, and additional lightning may be necessary. This can be solved by using an additional light source and detector operating outside the visible colour range. In practice this would mean using an infrared or ultraviolet light source and detector. Beyond that the setup is similar.

FIG. 2 shows an example of this implementation. A practical application of the setup is to let a square of 16 pixels in the lower right corner change from black to white at 10 Hz. A photo diode can then be positioned over this area of the display. The resulting signal will be stable and easy to read and interpret. 10 Hz is also low enough in frequency to get through any scaling engine. The pixel block position and the sensor position are marked in FIG. 2 with A.

### EXAMPLE 2

### Colour/light Difference

One can also use a test pattern that changes between two colours, and a photo detector which identifies the specific colour shown on the display. If the test pattern changes from colour A to colour B in a predetermined pattern then everything is fine, if not an alarm can be activated.

If operation in complete darkness is needed then it is possible to deactivate the detection logic when it is impossible to detect the colours. This will then indicate that it is insufficient light to operate this logic.

A variant of this method is to use two or more locations on the display which have a changing pattern. One photo detector can be used for each location.

### EXAMPLE 3

### Light Intensity

One problem with making a picture freeze detector is that in some application you need to use the display in both broad daylight and in almost complete darkness. This means that the light seen by the picture freeze logic will vary considerably. As it is seen from the first two implementation examples above, it might not be enough light to make the picture freeze logic work. This event has to be detected and the user has to be informed that the picture freeze logic can not work properly. This can be done by turning off an armed LED indicating that the picture freeze logic is armed. If this LED is off then no alarm can be activated. How this is indicated is application specific and not part of this invention disclosure.

One implementation is to select a block of pixels and make this block change in light intensity, and put an optical detector in front of these pixels on the display.

The detection logic is made such that it can detect if light is present (this can alternative be deduced from other information), and if the light on the test spot is changing at a specific pattern/frequency.

This pattern/frequency has to be clearly different from sources generating noise. The pattern/frequency must also be equal to or lower than half the frequency of picture updates.

The detection logic can trip an alarm if it detects that light is present and the light is constant. This condition indicates that the picture has frozen.

The logic can also give an indication if it fails to work due to lack of light.

### EXAMPLE 4

### Code Sensor

A preferred embodiment of the invention is independent of light, but has requirements which make it difficult to produce. It can be difficult to implement it without help from the TFT panel producer.

The principle of operation is as following:

On the TFT panel there are placed several sensors. These sensors are not reacting to light but are listening to the electrical signals in the TFT panel. In practise they will listen for electrical field, magnetic field or be directly connected to the pixel electronic. This might or might not be made invisible to the user. Conductive transparent wires exist and might be used.

The video signal is modulated in such a way that the pixels below these sensors are stimulated in a specific way. Preferably this can be made according to an algorithm which does not disturb the picture presented on the display.

Although the primary use of this invention is to detect if a display used for navigation on board a ship is being updated on a regular basis, the invention can also be applied in other areas where it is vital that the information presented on a screen is up to date.

In modern airports there are a large number of information boards. They are primarily used for marketing and to show flight information. In case one of they fails it is convenient if the service department was notified about this so they can fix the problem.

The present invention also covers a system which enables the notification to be done automatic. This will give a professional impression of the airport, and will also save costs. Nobody will then have to check if the information boards are working.

The same goes for stock tickers and many other similar applications.

Big newspapers often have large displays with marketing and news typically located in crowded places. If the computer associated with theses displays crashes, the information board can end up with showing the famous Microsoft blue screen. With the present invention, the service department can be notified of the problem, or the computer can be automatically restarted, instead of having the blue screen present for most of a day giving people walking by a good laugh,

The problem with information on a flight instrument that is not updated is obvious. This is also the case with other security specific applications in the chemical, nuclear field.

Throughout the description of the present invention, the phrase display panel means a TFT display panel. Future technology will allow other ways of making displays. Several forms of LED matrixes are especially promising.

The inventive method and system is therefore not to be considered to be restricted to TFT displays, but can be implemented on other types of displays that may freeze a picture.

1. Method for identifying a picture freeze situation on a display characterized by:
adding an electronic signature in the signal chain fed to the display;
detecting if the electronic signature is present on the display,
activating a warning unit if the electronic signature is not present.

2. Method according to claim 1, where the electronic signature induces a selected group of pixels to change from black to white.

3. Method according to claim 1, where the electronic signature induces a selected group of pixels to change in colour values.

4. Method according to claim 1, where the electronic signature induces a selected group of pixels to change between predefined patterns.

5. Method according to claim 1, where the electronic signature induces two or more pixels to change its physical properties every other time.

6. Method according to claim 1, where the electronic signature induces a selected group of pixels to change between different light intensities.

7. Method according to claim 1, where the electronic signature hides in the picture by using steganographic technology.

8. Method according to claim 1, where the detecting is performed by using a photo sensitive device reading the selected group of pixels.

9. Method according to claim 1, where the detecting is performed by using a device sensitive to the electrical and/or magnetic field emitted from the selected group of pixels.

10. Method according to claim 1, where the detecting is performed by directly reading the control signals sent to the selected group of pixels.

11. Method according to claim 1, further comprising the use of a watch dog timer.

12. System for identifying a picture freeze situation on a display comprising:
a device for adding an electronic signature in the signal chain fed to the display;
a device for detecting if the electronic signature is present on the display, and
a device for activating a warning unit if the electronic signature is not present.

13. System according to claim 12 further comprising a watch dog timer.
